(19) United States
(12) Patent Application Publication
(10) Pub. No.: US 2014/0346252 A1
(43) Pub. Date: Nov. 27, 2014

(54) SPRAY CONTAINER

(71) Applicant: Chris DAVIS, Cape Cirardeau, MO (US)

(72) Inventor: Chris DAVIS, Cape Cirardeau, MO (US)

(21) Appl. No.: 13/895,416

(22) Filed: May 23, 2013

(51) Int. Cl. B05B 11/00

(52) U.S. Cl. CPC B05B 11/0037
USPC 239/328

(57) ABSTRACT

A package for a liquid has a spray head with a manually operable pump and a tubular plastic neck connectable to the spray head. A liquid-holding bag made entirely of plastic film has two face panels with upper edges between which the plastic neck is sealingly fixed, a floor panel extending between lower edges of the face panels, and a pair of V-shaped side gussets between side edges of the face panels and each formed by a pair of subpanels meeting at a fold. Each gusset has at a lower end a gore forming a continuation of the respective fold and attached to the floor panel. The panels and gussets being connected together to form a closed interior that, when filled with liquid, expands the side gussets and orients the floor panel transverse to the face panels and gussets such that the bag can stand on the floor panel.

The invention relates to a package for a liquid, which package has a spray head that has a manually operable pump. A package of this type is also identified as a spray container and is used, for example, as consumer-level packaging for cleaning and disinfecting products.

In practical application, plastic bottles are primarily used for these packages that have a plastic neck made by blow molding. The bottles can be filled through the mouth of the plastic neck. After being filled, a spray head is attached to the plastic neck and the package is thus closed. Spray containers produced by blow molding are heavy and are dimensionally stable. As a result, large volumes of waste accumulate from the packaging. Recycling the blow-molded containers also presents problems.

A spray bottle comprising a blow-molded body has been disclosed in WO 2005/072880.

EP 1 233 915 [U.S. Pat. No. 6,976,712] describes a plastic-film package for a liquid. The package is a standup bag and has two face panels that are interconnected at their longitudinal edges. A bottom panel located between side panels and in the form of a supporting floor is provided at the lower end of the standup bag. A foldable top panel is provided between the face panels at the upper end of the standup bag. In addition, a removal opening is provided between the top transverse edge of a face panel and the associated edge of the top panel, at which opening a closure is installed. The closure can be folded over forward when the contents is dispensed and can be closed by a screw cap. Due to its reduced dimensional stability, it is not possible to combine the foldable closure with a spray head.

EP 1 524 195 [U.S. Pat. No. 7,331,917] discloses a plastic-film package for solid particulates that has two face panels, a plastic-film floor panel that is folded inward and attached to the lower edges of the face panels, and side gussets between the face panels. Above the side gussets, the face panels are joined directly to each other at their longitudinal edges by welds and create a two-layer head region of the stand-up bag, thereby allowing a reclosable closure to be provided in the form of a pressure closure.

The object of the invention is to provide a spray package for a liquid that is of low weight and that has reduced waste volume after being emptied. The spray package should exhibit high positional stability until it is completely emptied.

The object of this invention and the achievement of this object also comprise a package for a liquid as set forth in claim 1.

The package according to the invention is made of a plastic-film bag, a plastic neck attached to the plastic-film bag, and a spray head that is connected to the plastic neck and has a manually operable pump. The plastic-film bag has two face panels, a plastic-film floor panel that is folded inward, and side gussets that are provided between the face panels, wherein the plastic-film floor panel is attached to a lower edge of the face panels, and wherein the side gussets each have a film panel folded in a V-shape and are attached to the longitudinal edges of the face panels. The side gussets are closed at their upper end and have at their bottom end a triangular gore that creates a fold which is inserted between the film panels of the side gussets and is attached to the plastic-film floor panel. The face panels are joined at their upper end by a joining seam that closes the plastic-film bag. The plastic neck here is provided between the face panels at the top edge of the plastic-film bag and is attached creating a liquid-tight seam with the face panels.

The plastic-film bag is produced as a flat-lying plastic-film bag, and forms a stable package after it is filled. The package is filled through the plastic neck. After it is filled, the spray head is installed and the plastic neck is closed by the spray head. The spray head can be permanently attached to the neck. Use of a permanent connection may be appropriate, in particular, for toxic liquids or those that at least pose a health risk. For other less potentially hazardous liquids, the spray head can be detachably connected by screwthreads to the plastic neck. The detachable connection has the advantage that the spray head and the plastic-film bag can be separated after the package has been used, then recycled as separate parts.

Filling the plastic-film bag causes the side gussets between the face panels and the inward-folded plastic-film floor panel to expand. This produces a completely flat floor that provides the package with good stability. To use it, the package can be grasped by the spray head and the liquid product can be dispensed as a spray jet or mist by operating the pump. The package can subsequently be stored since the plastic-film floor panel provides the package with good stability. The spray package according to the invention is also characterized by good stability even when it is partly empty. According to the invention, the spray package according to the invention combines effective use characteristics with a reduced use of materials due to the use of thin plastic films.

The side gussets advantageously end below the top edges of the face panels and are each closed at their upper end by a triangular fold and a joint seam.

In a preferred embodiment of the invention, the face panels, the plastic-film floor panel, and the side gussets are made of a weldable plastic film, and all seams are thermal welds.

The plastic film is preferably a multilayer film that has a weldable layer made for example of polyethylene on the inside of the bag, and a polymer cover layer on the outside of the bag. The polymer cover layer can be a polymer that provides good mechanical properties to the plastic film, has high impermeability to gases and liquids, and is suitable for printing. The multilayer plastic film can be produced in the form of a coextruded film or a multilayer laminate, and can have at least one additional functional layer between the weldable layer and the cover layer so as to improve the mechanical properties or the impermeability to gases and liquids.

The spray head is provided with a manually operable pump that has, for example, a pump piston supported on a compression spring, as well as a check valve. The spray head is a preassembled modular component and comprises a dip tube connected to the pump and extending down through the plastic neck into the interior of the plastic-film bag.

The following describes the invention with reference to a drawing illustrating only one embodiment. Therein:

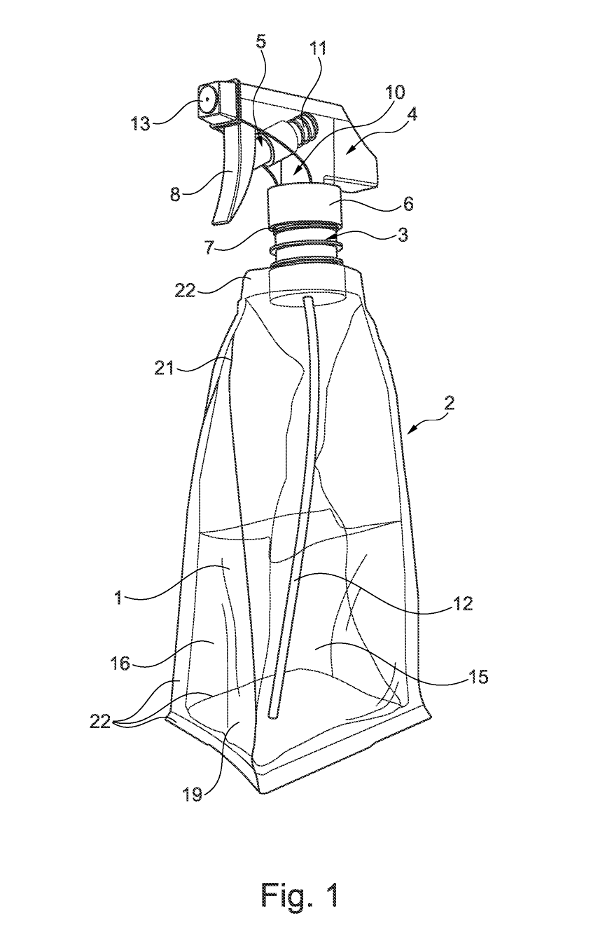

FIG. 1 is a perspective view of a spray package for a liquid;

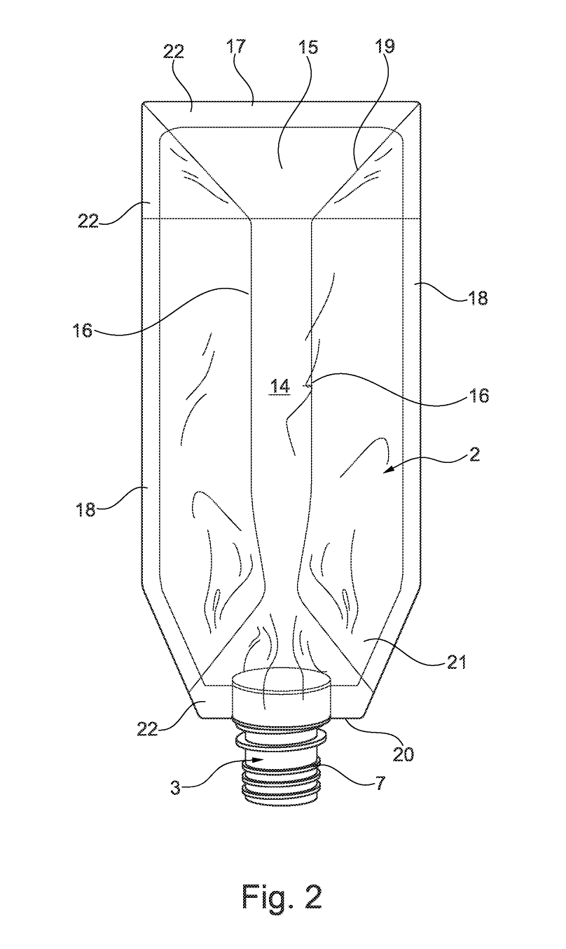

FIG. 2 shows the spray package of FIG. 1 before it is filled and without a spray head;

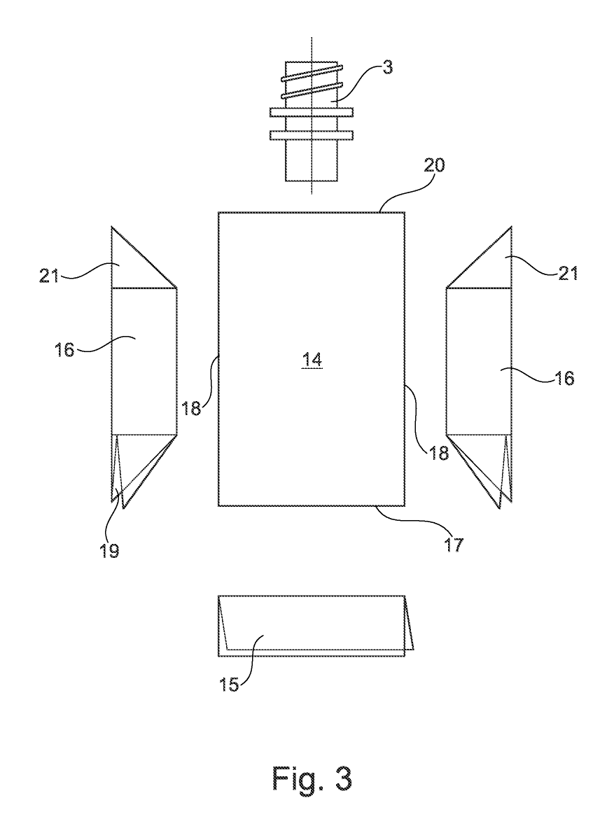

FIG. 3 is an exploded view of the package shown in FIG. 2;

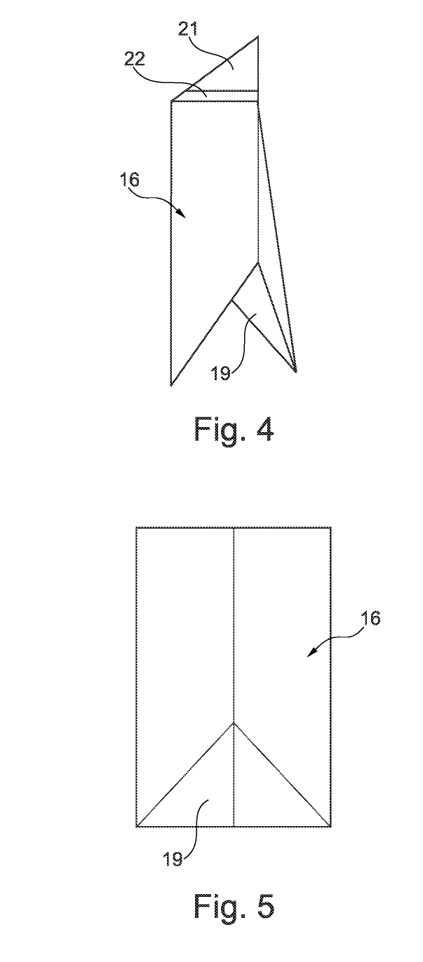

FIG. 4 is a detail view of the side gusset of the package shown in FIGS. 1 through 3;

FIG. 5 shows a flat plastic film strip including fold lines for making the side gusset shown in FIG. 4.

The package shown in FIG. 1 is filled with a body 1 of liquid and is comprised of a plastic-film bag 2, a plastic neck 3 attached to the plastic-film bag 2, and a spray head 4 attached to the plastic neck 3 and having a manually operable pump 5. The spray head 4 is a preassembled modular component and is attached to the plastic neck 3 by screwthreads. An internal screwthread is formed in a threaded ring 6 that is rotatably supported on the spray head 4 and that is screwed onto an external screwthread 7 of the neck 3. The pump 5 has an operating lever 8, a piston connected to the lever 8, and a check valve 10. In addition, a return spring 11 is provided that biases the lever 8 back into a starting position after it is operated. A dip tube 12 is connected to the pump 5 of the spray head 4 and extends down into the interior of the bag 2. When the pump 5 is operated, the liquid 1 is discharged from the front of the spray head 4 in the form of a spray jet or mist.

The bag 2 is made from a weldable plastic film and has two face panels 14, a plastic-film floor panel 15 folded inward, and side gussets 16 between the face panels 14, the floor panel 15 being attached to lower edges 17 of the face panels 14 and the side gussets 16 each including a V-shaped folded film panel and being attached to longitudinal edges 18 of the face panels. The side gussets 16 are closed at their upper ends and each have at their bottom end a triangular gore 19 that forms a gusset between the sections of the respective side gusset 16 and is attached to the floor panel 15. FIGS. 1 and 2 furthermore reveal that the face panels 14 are attached together at their top edges 20 by a joining seam that closes the bag 2, and that the neck 3 is provided between the face panels 14 at top edges 20 of the bag 2 and is attached so as to create a liquid-tight seal with the face panels 14.

The bag 2 is prefabricated to lie flat (FIG. 2). The bag can be filled with liquid 1 through the neck 3.

After the film bag has been filled, the spray head 4 is installed on the neck 3, thereby closing the fill mouth of the plastic neck. As illustrated in FIG. 1, the bag 2 forms a package with a flat rectangular standing self-supporting surface after it is filled. The self-supporting surface retains its shape regardless of the package's fill level, with the result that it is stable even when it contains only a small amount of liquid.

The side gussets 16 end below the top edge 20 of the face panels 14, and are each closed by a triangular fold 21 and a weld. All of the panels of the plastic-film bag are made of a weldable plastic film. All of the joints are preferably thermal welds 22.

The plastic film from which the face panels 14, the floor panel 15, and the side gussets 16 are produced is preferably a multilayer plastic film that includes a weldable layer made of polyethylene on the inside of the bag, and a polymer cover layer on the outside of the bag. The multilayer plastic film can have at least one additional functional layer between the weldable layer and the polymer cover layer in order to improve the mechanical properties or the impermeability to gases and liquids.

1. A package for a liquid, comprising a plastic-film bag, a plastic neck joined to the plastic-film bag, and a spray head connected to the plastic neck, wherein
the spray head has a manually operable pump, the plastic-film bag having two face panels, a plastic-film floor panel folded inward, and side gussets between the face panels,
the plastic-film floor panel is attached to lower edges of the face panels,
the side gussets are each a V-shaped folded film panel and are attached to longitudinal edges of the face panels,
the side gussets are closed at their upper ends and each have at their bottom end a triangular gore that creates a fold between the film panels of the side gussets and attached to the plastic-film floor panel,
the face panels are joined at their top edge by a weld that closes the plastic-film bag, and
the plastic neck is between the face panels at the top edge of the plastic-film bag and is attached to the face panels by a liquid-tight seal.

2. The package according to claim 1, wherein the side gussets end below the top edges of the face panels and are each closed at their upper end by a respective triangular fold and a weld.

3. The package according to claim 1, wherein the face panels, the plastic-film floor panel, and the side gussets are each made of a weldable plastic film, and the joining seams are thermal welds.

4. The package according to claim 3, wherein the plastic film is a multilayer plastic film that has a weldable layer made of a polyethylene on the inside of the bag and a polymer cover layer on the outside of the bag.

5. The package according to claim 4, wherein the multilayer plastic film has at least one additional functional layer between the weldable layer and the cover layer in order to improve the mechanical properties or impermeability to gases and liquids.

6. The package according to claim 1, wherein the spray head is detachably connected by screwthreads to the plastic neck.

7. The package according to claim 1, wherein a dip tube is connected to the pump and extends down into the interior of the plastic-film bag.

8. A package for a liquid, the package comprising:
a spray head having a manually operable pump;
a tubular plastic neck connectable to the spray head; and
a bag made entirely of plastic film and having:
a pair of face panels having welded together upper edges between which the plastic neck is sealingly fixed,
a floor panel extending between lower edges of the face panels, and
a pair of V-shaped side gussets between side edges of the face panels, each formed by a pair of subpanels meeting at a fold, and each having at a lower end a triangular gore forming a continuation of the fold and attached to the floor panel, the face panels, floor panel, and gussets being connected together to form a closed interior that, when filled with liquid, expands the side gussets and orients the floor panel transverse to the face panels and gussets such that the bag can stand on the floor panel.
